(19) United States
(12) Patent Application Publication
(10) Pub. No.: US 2012/0275927 A1
(43) Pub. Date: Nov. 1, 2012

(54) Water-leak Damage Prevention System Utilizing A Unitized Tank Collection Flange Reservoir System

(76) Inventor: Hotaek Rhim, Northborough, MA (US)

(21) Appl. No.: 13/097,857

(22) Filed: Apr. 29, 2011

(51) Int. Cl. F04B 49/00; G08B 21/00

(52) U.S. Cl. 417/36; 340/605

(57) ABSTRACT

Abstract of Disclosure The present invention is a method means of preventing water-leak damage to any hot water system providing means, or any water storage means such as washing machines, water storage means used in manufacturing facilities, or any water volume means where the prevention of water-leak damage is desired, vital, or essential. Water-leak damage is prevented using a collection flange reservoir system means at the base of a hot-water tank means. Said collection flange reservoir system means can be an afore added component to a hot-water tank means or a feature of OEM (Original Equipment Manufacturer) production means, which is a novel feature and further intention of the present invention.

### FIELD OF THE INVENTION

This invention relates to detecting and preventing accidental water leaks from a hot-water accumulation tank system means inside of homes and businesses, but not restricted to homes and businesses, nor restricted to hot-water tanks systems.

### BACKGROUND OF THE INVENTION AND PRIOR ART

Water leaks in homes, high rise condominiums or apartments, and businesses, and even extending to novel applications of such systems in sea craft and huge cruise liners can amount to serious damage thus causing huge amounts of monetary expense and affecting such important insurance requirements and costs associated with damage claims.

This detailed in this web site: http://www.rmiia.com/Homeowners/water_damage.htm.

And the Insurance Information Institute at: http://www.iii.org

The source of water-leaks can emanate from home appliances such as hot-water heater systems, dishwashers, or washing machines; as well as freezers, ice machines, which are usually located in the basement of homes. The most common water-leak problem comes from hot-water tank systems, which if left to leak water can and usually does cause serious damage to basement belongings.

In high rise building such as condos or apartments, serious water-leak damage is most pronounced more severe than in most homes.

Current prior art as stated in the patents of Tornay Patent Application No. US 2005/0224118 A1 uses an approach to monitor overall water system pressure deviation in a building, and not at the source of a leak, which occurs at the hot-water tank source means. Prior art of Hoiberg U.S. Pat. No. 5,153,564 is a battery operated quick fix for monitoring and alerting of a water leak, but not preventing such leak(s) from spilling over a basement floor by containing said leak(s). Prior art of Newmann et al. U.S. Pat. No. 6,675,826 B1 uses a method of shutting off the main water supply line and not preventing flooding by containing such leak(s) by using any contained reservoir methodology that is an embodiment to a hot-water tank feature.

In contrast, the novelty of the present invention remains that it prevents water-leak damage by containing said water-leak(s) within a unitized water-tank collection reservoir means. This novelty of the present invention allows for the hot-water system to remain in operation whilst repairs can be made. This is due to the novel dual water sensor and controlled pumping action of a strategically placed water pump and pump drain embodiment. This novelty is an improvement over current prior art and teaches that a hot-water system means can remain fully operative whilst undergoing repair to said water leak(s) and further that no water leak(s) will cause any damage to surroundings due to a novel water collection reservoir, which is an embodiment of said present invention.

### SUMMARY OF THE INVENTION

One aspect of embodiments of said present invention is to prevent any discontinued operation of a hot-water system due to a water leak(s) in the hot-water tank system means before and during a repair engagement.

Another aspect of embodiments of said present invention is to interminably and continuously monitor for any hot-water tank leaks in a hot-water tank system by means of utilizing a dual water sensor means to monitor a lower and upper level of water contained in a water collection reservoir means.

Another aspect of embodiments of said present invention is for an ample pump capacity water pump means to continuously and cyclically, pump water leaks from said contained water collection flanged reservoir surrounding said hot-water tank means.

Another aspect of embodiments of said present invention is for the inclusion of a tarpaulin kit assembly that is part and parcel to said present invention of a Water-leak Damage Prevention System Utilizing A Unitized Tank Collection Flange Reservoir System.

Another aspect of embodiments of said present invention is for providing an OEM hot water tank feature that incorporates as a further embodiment of said present invention a built-in attached unitized tank collection flanged reservoir means as a manufactured feature of an OEM product.

Another aspect of embodiments of said present invention is for utilizing a special micro-controller algorithm that automatically, interminably and continuously monitors by said dual water level sensors and controls the actions of said water pump to operate form a precise turn-on to a turn-off state of pumping action to control said water leak and maintain said water leak within the confines of said water collection reservoir means.

Another aspect of embodiments of said present invention is for the periodic flushing accumulated sediments in said hot-water tank by the operation and control of said solenoid control valve means that flushes sediments into said water collection reservoir means and further has said sediments pumped out through an external remote drain means.

Another aspect of embodiments of said present invention is for the micro-controller module means to sound an audible alarm alert and to further be in communication with an external means for calling and alerting a homeowner by means of a remote phone or other wireless means of a water leak in progress.

### BRIEF DESCRIPTION OF THE DRAWINGS

FIG. 1 is an overview of said present invention embodiments.

FIG. 2 is a detailed graphic representation of the invention embodiments.

FIG. 3 is an electrical schematic block diagram of the water leak detection system and its control features.

FIG. 4 is the electrical diagram of the dual water sensor subsystem.

FIG. 5 is the construction assembly for the water collection reservoir fire resistant tarpaulin.

FIG. 6 is a drawing of the drain water connection.

FIG. 7 is a drawing of a further intention of the present invention graphically describing an OEM in-production fabricated unitized flanged water collection reservoir feature.

### DETAILED DESCRIPTION OF THE PREFERRED EMBODIMENTS

The water-leak damage caused by home appliances is real and it can amount to serious damages for residential homes, high rise condominiums or apartments. The water-leak damage is serious to cause thousands or tens of thousands of dollars in damages, as well as increasing homeowner insurance rate changes.

The water-leak can come from home appliances such as a hot-water heater, a dishwasher, or a washing machine. The water-leak caused by washing machines or dishwashers is rare in nature, although it can cause serious water-leak damages per se. The most common water-leak damages come from hot-water heaters. The hot-water heater has no built-in end-of-life indicator, or warning for a water-leak. Therefore, water will leak from the hot-water heater, without any warning or indication, when it comes to its end-of-life period.

In residential homes, the hot-water heater or washer and drier are usually located in the basement. If the basement is not finished, it can tolerate some amount of water-leak. If the basement is finished, it can cause serious damage. The problem of any water-leak is far more serious if it is in such places as condominiums or apartments in high rise buildings.

There are prior art devices in the market to warn of water-leaks, or to minimize the water-leak by turning-off cold water supply to the hot-water heater. It should be noted that these devices are not designed for preventing water-leak damages. If the home owner is away from home when the water starting to leak and an alarm is set, the water will continuously leak until the water-leak is discovered upon return to home. If the cold water supply is shutoff, the water in the hot-water heater will continuously leak until proper care is given to the hot-water heater.

In general, the typical hot-water heater contains 40-Gallon to 80-Gallons of water, which is enough volume to cause serious damages, even after the cold water supply to the hot-water heater has been turned-off.

The problem is even more serious if the water-leak happens in high rise condominiums or apartments. In this case, the water-leak can flow down, and can cause expensive damages for multiple units below.

Therefore, the ultimate solution is to provide a method to prevent any and all water-leak damage. The present invention is designed and embodied to prevent expensive damage caused by water-leaks. This is done by detecting the water-leak, capturing leaky water into water-pan, and pumping-out leaky water, before it can cause serious property damages.

The present invention through its embodiments teaches and accomplishes this problem of water leak damage and interminably and continuously prevents same.

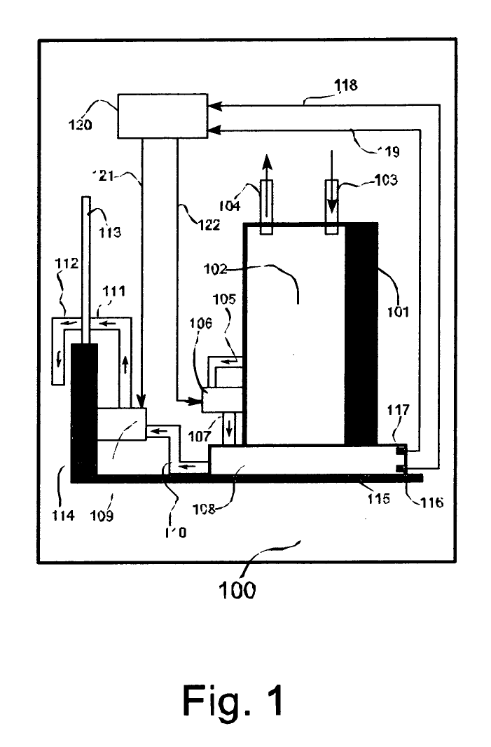

FIG. 1 illustrates a typical hot-water tank system utilizing the present invention's embodiments 100.

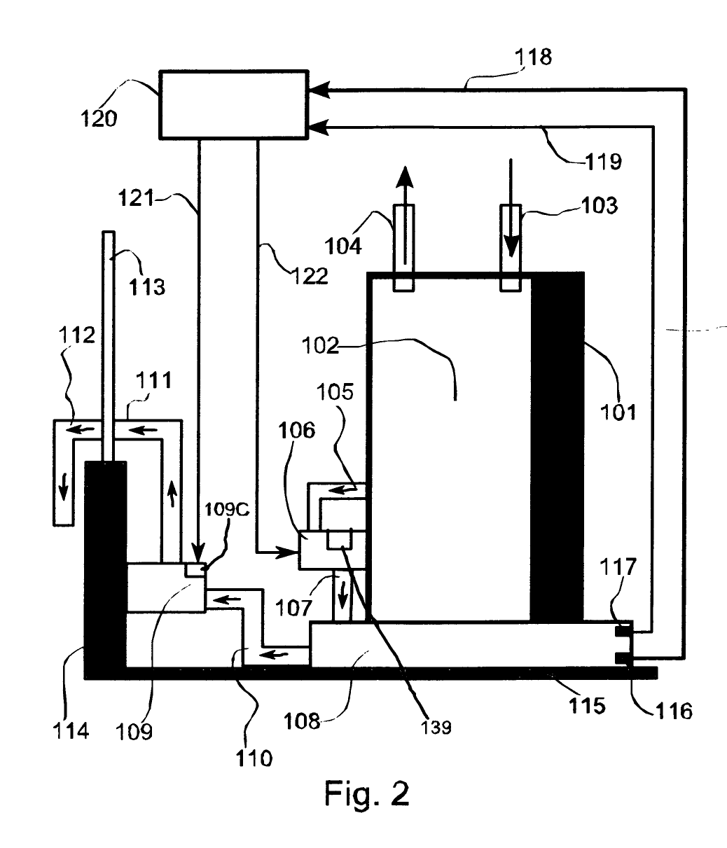

FIG. 2 is an embodiment of said present invention and refers to a detailed and complete hot-water tank system with said present invention embodiments 100, with a hot-water tank 101 positioned on the floor 115 of a typical installation with cold water inlet pipe 103 and hot water outlet pipe 104 being used in the distribution of accumulated hot water for general usage in a consumer environment. The normal drainage faucet 105 is connected to a solenoid valve control 106 that remains a normally shut-off state until it is enabled and turned on by a command from the micro-controller module 120 and this electrical command signal is sent along electrical connection 122 between micro-controller module 120 and solenoid valve control 106. This action takes place periodically to eliminate accumulated sediments in the hot-water tank means 101, and performs as a methodology for extending the life of said hot-water tank 101. The output of said solenoid valve 106 is a pipe 107 that allows water to flow into a contained water collection reservoir 108 positioned and remaining center aligned beneath the base of said hot-water tank 101. Water collection reservoir 108 is used to collect any water from either a water leak from said water tank 101 or from the periodic water tank 101 flushing of accumulated sediments by solenoid control valve 106 that feeds accumulated sediments into said water collection reservoir 108. Any water in said water collection reservoir 108 is pumped out by water pump 109 and said water in collection reservoir 108 flows through collection reservoir outlet pipe 110 into said pump 109 and through outlet pipe 111 then being fed through a foundation base 114 and building support wall 113 to the outside environment through an outside pipe 112. This action of water being pumped out by said water pump 109 is controlled by micro-controller module 120 and its associated algorithms. Water collection reservoir 108 also has a dual water sensor means, which is comprised of a lower-level water sensor 116 and an upper-level water sensor 117 that is connected to micro-controller module 120 by electrical connections 118 for said lower-level water sensor 116 and electrical connection 119 for said upper-level water sensor 117. Water pump 109 receives its signal command to turn on or off by electrical connection 121 from micro-controller module 120.

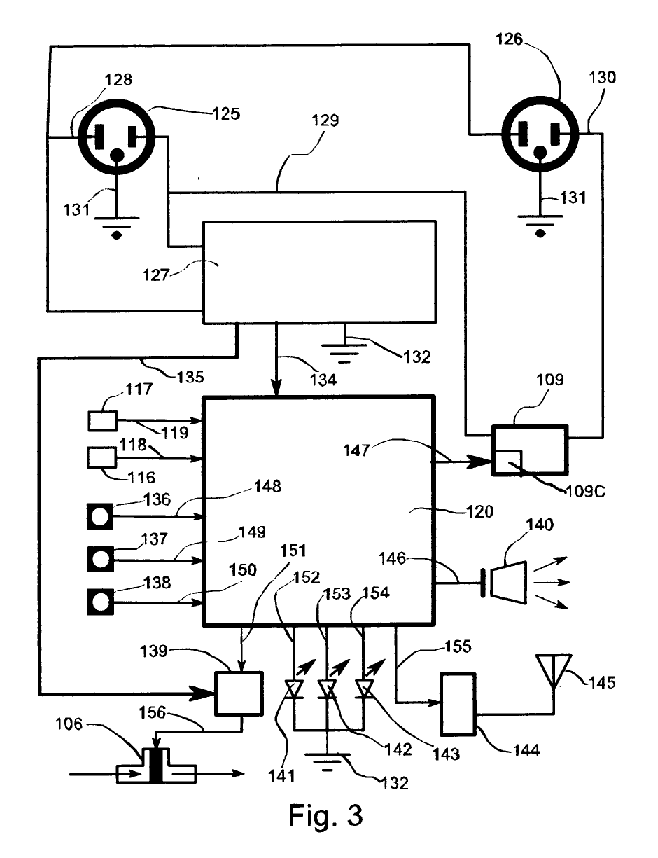

FIG. 3 represents a functional electrical block diagram of the water-leak detection and prevention system 100. Said micro-controller module 120 is programmed with a series of instructions or algorithms that generates precise interminable control, monitoring, and prevention of a hot-water tank distribution system 100 from causing leak damage if said hot-water tank 101 fails to contain water due to leaks or other sporadic accidental means. All power for said water leak prevention system 100 is generated from the AC-to-DC converter module 127 by converting AC power mains voltage received from an AC type plug 125 with connection wires for AC line (Black) 129 and AC Neutral (White) 128. AC ground (Green) 131 is the common AC ground for all AC operated components of said water leak prevention system 100. AC lines 128 and 129 are electrically connected to the input of AC-to-DC converter 127. Said AC-to-DC converter 127 supplies a low DC voltage bus of plus 5 (five) volts 134 with reference to the DC ground 132 and a DC voltage bus of plus 24 (twenty four) volts 135 with reference to DC ground 132. Said +5 volts 134 and +24 volts 135 are used to power said micro-controller module 120 and solenoid valve 106 respectively. The novel embodiments of said present invention of said water-leak detection and prevention system 100 utilize algorithms to interrogate and continuously monitor water upper-water sensor 117 by said upper electrical connection 119 and lower-water sensor 116 by said lower electrical connection 118. Micro-controller 120 continuously monitors and senses the status of said maintenance and test push button switch 136 by electrical connection 148, said alarm-off switch 137 by electrical connection 149, and system reset switch 138 by electrical connection 150; and further it responds to any change in the status of these switches as part of said novel algorithms for micro-controller 120 task of interminable monitoring. Said water-leak damage prevention system 100 features embodiments of system status LED lights for a system ready status light indicator 141 that is electrically connected by line 152 to indicate a lighted condition when said system 100 is ready for operation, said alarm-on LED status light indicator 142 that is electrically connected by line 153 to indicate when said audible alert alarm 140 is enabled or not, and maintenance and test LED light indicator 143 electrically connected by line 154 as well as all LED indicator lights having a common DC ground 132. Audible alert alarm 140 is connected to said micro-controller 120 by electrical line 146 and will audibly announce an alert condition of any detected water leak. Micro-controller 120 monitors and interrogates said maintenance/test switch 136 and if said switch is pushed, a logic signal change takes place on electrical line 148 that signals said micro-controller 120 to send a signal along electrical line 151 to said solenoid driver circuit module 139 and said solenoid driver 139 applies 24 VDC from line 135 to line 156 to solenoid 106, this action flushes water from said hot-water tank 101 into said water collection reservoir 108 and this action is a methodology for periodically cleaning and flushing away accumulated sediments from said hot-water tank 101 as a methodology of extending the useful lifetime of said tank system. During this time period of flushing, both lower-level sensor 116 and upper-level 117 are interrogated by said micro-controller 120 for the presence of water levels in said water collection reservoir 108, when said collection reservoir 108 is filled, a signal is sent to said micro-controller 120 and said controller 120 sends a signal to said water pump controller circuit 109C turns on water pump 109 that is powered by said AC power mains through AC plug 126 with connections to pump by electrical lines 129 and 130. Said pump continues to pump water out of water collection reservoir 108 until said water level diminishes to a level below that of said lower-level water sensor 116, then said water pump 109 shuts off and remains in that state until either another flush test is triggered or there is a sporadic water leak from said hot-water tank 101. If there is sporadic water leak from said hot-water tank 101, said water from said leak will be collected by water reservoir 108 and as said leaking water accumulates in water collection reservoir 108, once a lower level amount of water comes in contact with said lower-level water sensor 116 a signal is sent along line 118 and it is detected by micro-controller 120. Further when said water level reaches said upper-level water sensor 117 it now sends another signal along line 119 to micro-controller 120 and this signal completes a logic condition in said algorithms that turns on said water pump 109 at a precise time that prevents any water from over spilling onto a floor 115 as shown in FIG. 2, said water pump 109 will continue to pump out water as long as there is a sustainable level of water to communicate with both lower-level water sensor 116 and upper-level water sensor 117. This novel action and intention of said present invention teaches that there is novelty in said methodology of water-leak damage prevention by said present invention that is interminable and continuous over time until a repair condition overrides the emergency. Another intention and novelty of said present invention is to have said hot-water tank heating system still functioning in some capacity for hot water generation and usage. Said audible alert alarm 140 is used to locally announce an emergency leak condition. Another novelty and intention of said present invention is for simultaneously sending an audible alert alarm locally within a home or building sectional area and to send an RF wireless signal to a remote locale such as a computer, or computer controlled phone line annunciating system in order for said alert alarm to be acknowledged by someone that can attend to said emergency leak situation. Another novelty and intention of said present invention is for linking said water-leak damage prevention system 100 by RF wireless transmission to a Zigbee or similar RF wireless residential or commercial building energy efficiency and control system for further assurance of sporadic hot-water tank system leaks. Upon detecting a water leak, said present invention will send an alert signal along line 155 to a wireless RF transceiver 144 and said transceiver 144 transmits and radiates an encoded RF signal to antenna 145 where it is propagated into the atmosphere for remote reception by a designated receiver.

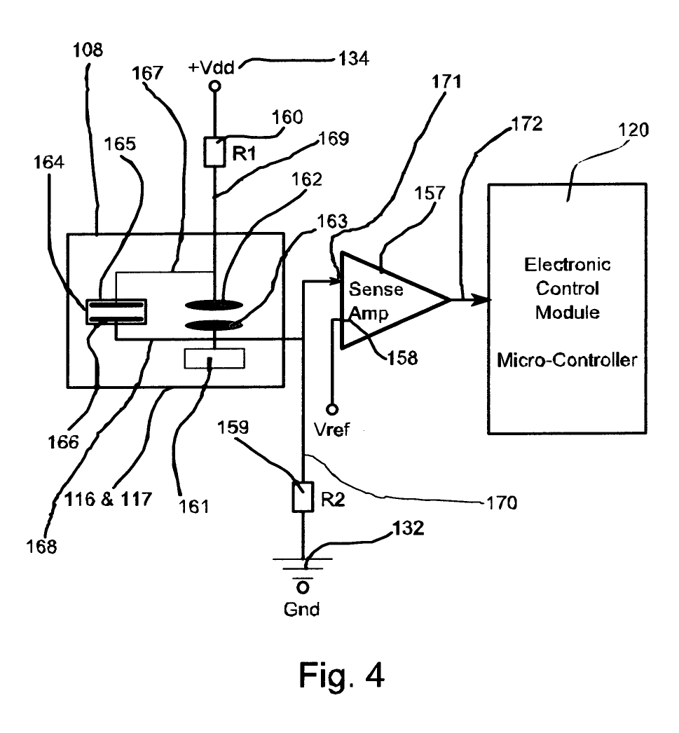

FIG. 4 references an embodiment of said water detect sensors for said lower-level sensor 116 water level detection and said upper-level sensor 117 water level detection. Each water level sensor component 164 (116 & 117 as specifically noted in FIGS. 1,2, and 3) is comprised of conductors plates 165 and 166 with an air space between them, which further comprises and is defined electrically as a capacitor. For those steeped in the art it is obvious that a capacitor's dielectric determines the permittivity of an established electric field set up between said conductive plates 165 and 166 once a voltage is established between said plates. Therefore comprehending said water level sensor 164 (116 & 117 as specifically noted in FIGS. 1,2, and 3) as a capacitor with a dielectric established by the air between said plates, and the dielectric constant for air being 1 and the dielectric constant for water being 85 or greater; it should be obvious to anyone steeped in the art that capacitance is directly proportional to the dielectric constant; and further that a measurable change in capacitance can be detected when water flows through said water level sensor 164 (116 & 117 as specifically noted in FIGS. 1,2, and 3). The change in capacitance of said water sensor is electrically felt at the input 171 of sense amplifier 157 and this signal change is developed at the electrical series point between resistor R1 160 and R2 159. Resistor R1 160 is connected between said +5 volt supply voltage 134 and said upper plate of water sensor 164 (116 & 117 as specifically noted in FIGS. 1,2, and 3) and R2 159 is connected between lower plate of 164 (116 & 117 as specifically noted in FIGS. 1,2, and 3) and DC ground 132 fed from said sense amplifier 157 to said micro-controller 120 by electrical connection 172, which is the output of said sense amplifier 157. When water comes in contact with said lower-level water sensor 117 it is registered in said micro-controller 120 for evaluation and decision making of turning on said water pump 109 when it receives a second signal from said upper-level water sensor 117. Vref 158 is a reference voltage used for said sense amplifier 157 voltage level sensing and this reference voltage 158 is what said water level sensors 164 (116 & 117 as specifically noted in FIGS. 1,2, and 3) and miniature float means 161 are compared against for pump turn on signals to said micro-controller 120.

Also in FIG. 4 another embodiment of a second method means for detecting the presence of water in said water collection reservoir 108, is a strategically positioned miniature float embodiment comprised of; an upper electrical contact plate 162 and a lower electrical contact plate 163. Said lower plate 163 is mechanically attached to a float means 161 and when there is water present, said float means 161 will rise with said water in collection reservoir and cause an electrical connection to be made between plates 162 and 163. Said plates 162 and 163 of said miniature float means 161are connected in parallel with said water level sensor 164 (116 & 117 as specifically noted in FIGS. 1,2, and 3) for redundancy of interminable monitoring and detection of any sporadic hot-water tank 101 leaks.

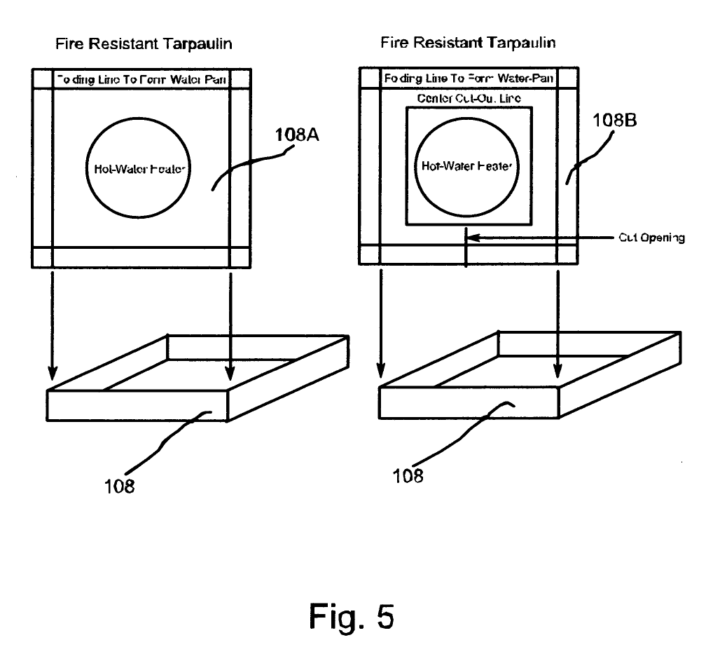

In the embodiment illustrated in FIG. 5, a fire resistant and waterproof tarpaulin sheet or some polymer or metallic or complex combination material means 108A and 108B is provided in a kit form that is part and parcel to said present invention's production consumer package or of an independent tarpaulin or other said polymer or metallic or complex combination material means. Using a supplied instruction set, one can easily cut out and fold over to make a flanged water-leak collection reservoir 108 that is positioned underneath said hot-water tank 101. This is used for all installations of said present invention, for on-site fabrication of said water collection reservoir 108 in any existing or new build homes, condos or apartments.

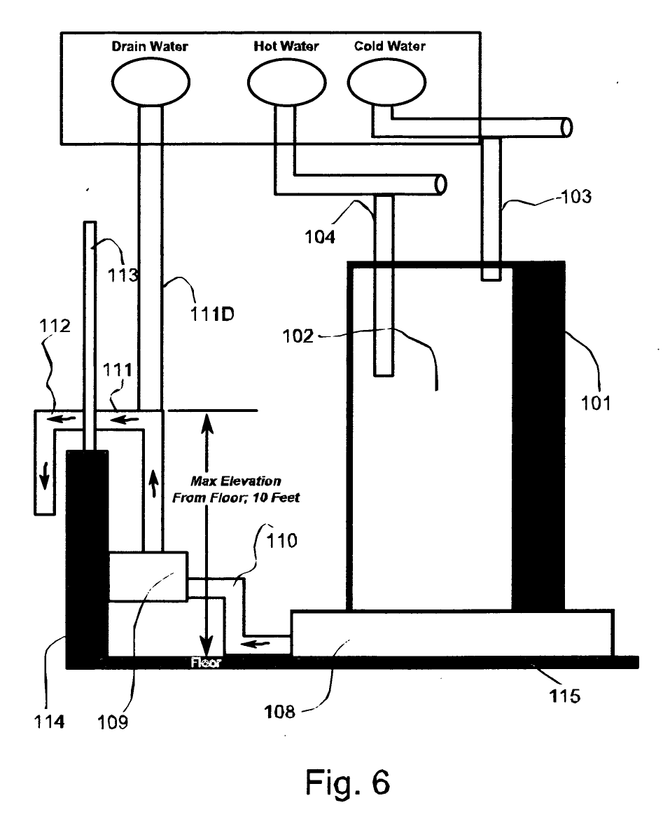

In the embodiment illustrated in FIG. 6 it is illustrated how high said water outlet pipe 111 can be elevated to flow through building wall 113 to outside through outside pipe fixture 112. Suggested maximum elevation for outlet pipe is ten feet from floor 115. Also another arrangement of said embodiment is to connect outlet pipe 111D to an existing drain-water source drain.

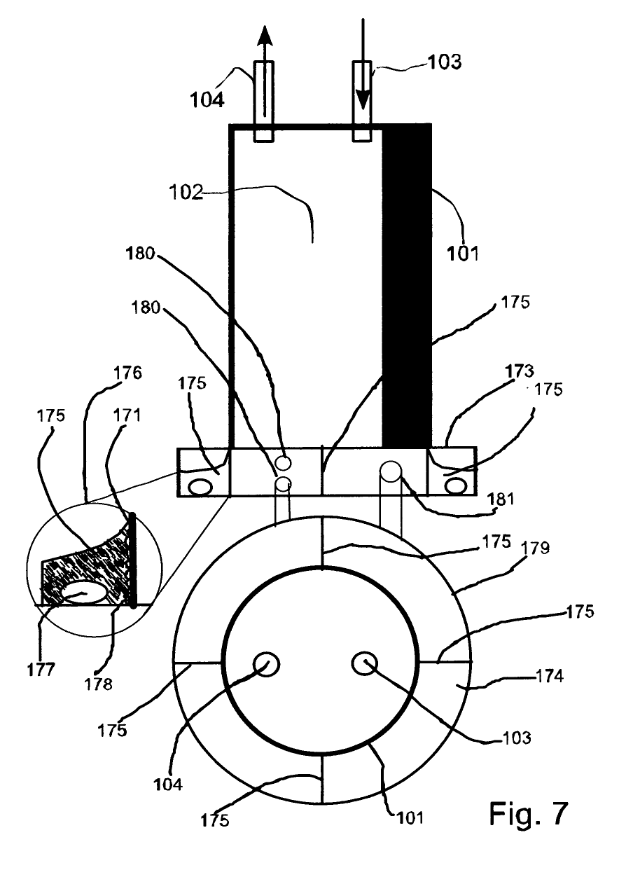

In the embodiment illustrated in FIG. 7, and another feature and intention of said present invention, is for a permanent water collection flanged reservoir 173 to be fabricated and constructed as a permanent improvement and feature over existing prior art that is seen as an attachment to a typical prior art hot-water tank means 101. FIG. 7 illustrates the components of said permanent water collection flanged reservoir 173, whereby a metal floor base means 174 is centered and welded to said hot-water tank 101 in a production setting means. A base circumference metal flange wall 179 is welded and fabricated around the full circumference of said metal floor base 174 and forms a water tight permanent water collection flanged reservoir 173. Support braces 175 are inserted and welded around said metal floor base 174 and said base circumference metal flange wall 179 at a multiplicity of positions, for maximum support and strength. An expanded view 176 of said support braces 175 shows a flow through hole 177 fabricated on each support brace 175 to allow water flow throughout said permanent water collection flanged reservoir 173. Lower and upper water-level sensor knock-out hole patterns 180 or holes 180 are fabricated in said base circumference metal flange wall 179 and water-pump pipe knock-out hole patterns 181 or holes 181 are also fabricated in said base circumference metal flange wall 179. These added improvements and intentions of said present invention are methodologies of improvement over prior art hot-water tanks and provides for an alternatives and accommodations for hot-water tank manufacturers to utilize as value added product features.

An embodiment is an implementation or example of said invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments of said present invention. The various appearances of “an embodiment,” “one embodiment,” or “some embodiments” are not necessarily all referring to the same embodiments.

If the specification states a component, feature, structure, or characteristic “may,” “might,” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Said present invention is not restricted to the particular details described herein. Indeed, many other variations of the foregoing description and drawings may be made within the scope of said present invention. Accordingly, it is the following claims including any amendments thereto that define the scope of said present invention.

What is claimed is:

1. A water-leak damage prevention system means comprising:
an electronic control module means comprising;
a programmable microcontroller module means;
a microcontroller custom program means;
a functional solenoid in mechanical and fluidic connection and communication with a valve shut-off and turn-on means;
a functional solenoid control means, which is in electronic communication with said electronic control module means;
a functional water pump and motor means, which is in mechanical and fluidic connection and communication with a water collection flange reservoir system means for pumping water out of said reservoir collection system means;
a functional pump motor control means, which is in communication with said electronic control module means;
a unitized hot-water tank collection flange reservoir system means that is part and parcel to a special hot-water tank means with a featured collection flange reservoir system means of an OEM (Original Equipment Manufacturer) production means;
a lower water level sensor means mounted at the bottom of a water-pan reservoir means;
and is in communication with said electronic control module means and detects water accumulation in said water-pan reservoir whenever said water supply commences leaking;
and this leak detection activates an alarm means to audibly indicate an alert situation;
an upper water level sensor means, which is in communication with said. electronic control module means mounted at the top portion of said water-pan reservoir means;
and is in communication with said electronic control module means;
and whenever said upper-sensor means detects water, said control system module means turns on said water pump motor means and removes water from said water-pan reservoir means;
a maintenance and system test means, which is in communication with said electronic control module means that by manual means or pre-programmed means causes a water flushing action to take place to remove sediment from hot-water tank means;
a system reset means, which is in communication with said electronic control module means;
an audible sound alarm means, which is in communication with said electronic control module means;
a light alarm means, which is in communication with said electronic control module means;
a wireless transceiver module means for communications with a wireless transceiver central control unit means;
a method means for connecting said wireless transceiver central control unit to an auto-dial or other external alarm alert means, which is in communication with said electronic control module means and alerts said wireless transceiver central control unit to send an alarm method means translating an emergency water-leak condition;
a shut-off valve means mechanically connected to and controlled by said solenoid means;
a fluid collection flange reservoir system means to collect, capture, and contain a water-leak fluid whose method means interminably and non-compromisingly prevents water-leak damage;
and said fluid collection flange reservoir system can be a feature production part of a special hot-water tank system means that is another intention of said present invention.

2. The system of claim 1, whereby accumulated water in said water-pan reservoir is removed and said system control module turns-off said water pump-motor.

3. The system of claim 1, whereby if said water leak is continuous; said water pump-motor is precisely, cyclically, and automatically turned on-and-off until leak is given proper attention and repair.

4. The system of claim 1 that has said discharged water hose pipe means connected to any nearby water drain means, washing machine water drain means, or a pump-out path means that pumps said discharged water to an external deposit means via a wall outlet means.

5. The system of claim 1, whereby said water-leak prevention system means operates with an optional sequential routine system maintenance algorithm that allows for periodic hot water reservoir cleaning by removal of clogging sediments;
and said sequential routine system maintenance algorithm can be activated by a manual or a pre-programmed periodic action event.

6. The system of claim 1, whereby said optional routine system maintenance algorithm proceeds with said action to automatically open a drain-faucet means and further;
Removing accumulated sediments in unison with discharged water and further;
any discharged water is removed by said pump-motor means, when said discharged water rises from said lower-sensor means to said upper-sensor means;
and said action is utilized to extend the life of said hot-water heater means.

7. The system of claim 1 and method recited in claim 5 and claim 6, in which said water pump will continue to pump-out water until such time that both said lower-sensor means and said upper-sensor means detects no water, thereafter said water pump will shut off and remain in this state until a command signal recycles afore mentioned sequence.

8. The system of claim 1, in which a water-leak collection means is provided by a tarpaulin assembly kit means that is part of said consumer water-leak prevention system means and is assembled and applied by said consumer utilizing a set of construct instructions provided by said water-leak system instruction set means.

9. The system of claim 1 and method recited in claim 8, in which said tarpaulin assembly completely surrounds the bottom base of said hot-water tank means and maintains a water-tight volume for water-leak collection contained therein.

10. The system of claim 1 and method recited in claims 8 and 9, in which said hot-water tank means is constructed with a permanent collection flanged reservoir means that is part of said hot-water tank features of prescribed assembly and production as claimed in said present invention herein.

11. The system of claim 1, in which said water-leak detection means causes direct action of said lower sensor detecting water in collection reservoir and sets off an audible alert alarm means.

12. The system of claim 1, in which said water-leak detection means causes direct action of said upper sensor to detect an upper limit water level in said collection reservoir and enable said electronic control module to communicate with pump motor control module to turn on said pump motor and set off an audible alarm.

13. The system of claim 1 and as recited in claim 11 and claim 12, in which water is detected as being of ample amount to turn on said water pump to pump out water in said collection reservoir and with said water-leak emergency condition existing; a wireless transceiver that is part of said present invention sends out an rf radio signal to a remote location to alert and summon for help and said wireless transceiver rf radio signal continues to send said emergency signal until it is acknowledged by a remote location receiver and acted upon by a consumer or other human monitor.

14. The system of claim 1 and claim 13, in which said wireless RF radio signal transceiver can be a zigbee designed remote control residence or commercial building monitoring and control system or any other type of wireless rf radio signal transceiver system utilized for remote control residence or commercial building monitoring and control systems.

15. The system of claim 1, in which said micro-controller module programming utilizes an algorithm that precisely calculates pump turn-on and turn-off time determined by pump capacity data that insures said water pump will only operate when there is water in said collection reservoir and this action is enabled to eliminate pump motor from overheating.

16. The system of claim 1 and method recited in claims 11-13, in which a dual water sensor system is utilized for water-leak prevention.

17. The system of claim 1, in which a hot-water maintenance feature means is utilized to extend the life of said water tank, whereby said maintenance feature means performs a periodic opening of hot-water tank drain-faucet means to remove accumulated sediments in said hot-water tank means.

18. The system of claim 1 and method recited in claim 15, in which said hot-water maintenance feature means can be enabled and place into action by the push of a trigger switch means.

19. The system of claim 1 and method recited in claim 15, in which said hot-water maintenance feature means can be enabled automatically and periodically by an embedded algorithm in said electronic micro-controller control module means; and can be initiated manually by a consumer or by said embedded algorithm.

20. The system of claim 1, in which an oem (original equipment manufacturer) production means of said present invention is for the incorporation of a permanent collection flanged reservoir means adhered to said hot-water tank means with provisions for installing said lower-level and upper-level water sensor means and water pump outlet pipe means and remains as further features and intentions of said present invention as a further embodiment and novelty.
